(19) United States
(12) Patent Application Publication
(10) Pub. No.: US 2008/0119989 A1
(43) Pub. Date: May 22, 2008

(54) CHILD ABANDONMENT PROTECTION SYSTEM

(76) Inventors: Matthew B. Henning, Murphy, TX (US); Melanie S. Henning, Murphy, TX (US)

Correspondence Address: Michael A. O'Neil;Michael A. O'Neil, P.C., Suite 820, 5949 Sherry Lane, Dallas, TX, 75225, US

(21) Appl. No.: 11/940,870

(22) Filed: Nov. 15, 2007

Related U.S. Application Data
(60) Provisional application No. 60/866,620, filed on Nov. 21, 2006.

(51) Int. Cl. B60R 22/48

(52) U.S. Cl. 701/45

(57) ABSTRACT

A system and method for preventing the unintentional abandonment or leaving of a child in an unattended vehicle utilizes an electronic system installed on a vehicle and a sensor installed on a child safety or car seat, or on a vehicle itself, to detect when a child has been unintentionally left in an unattended vehicle. If the electronic system determines that a child has been left, a signal is communicated via a transmitter to a parent, care provider, other individual, and/or police or other rescue personnel so as to alert same.

### CLAIM OF PRIORITY

This application claims priority of prior provisional Application Ser. No. 60/866,620 filed Nov. 21, 2006, the entire content of which is incorporated herein by reference.

### DESCRIPTION OF THE DRAWINGS

FIG. 1 is a plan view showing the child abandonment protection system of the present invention in use on a vehicle;

FIG. 2 is a perspective view illustrating the child abandonment protection system of the present invention; and

FIG. 3 is a flowchart comprising the steps of practicing the method of the present invention.

### DESCRIPTION OF THE INVENTION

The serious problem of children dying as a result of being unintentionally or inadvertently abandoned or left in hot vehicles is growing in the United States. In 2006 alone at least 26 children died as a result of being unintentionally left inside vehicles. In 2005 there were at least 42 such child fatalities. Based on reports, since 1998 there have been at least 300 deaths of children in the United States as a result of being unintentionally left in unattended vehicles.

These accidents commonly occur when children are placed in child safety seats or car seats which are mandated by law for small and/or young children. As is well known virtually every vehicle on the road, and all newer vehicles, are equipped with front air bags. Because of the risk of serious injury to small children from air bag deployment, and from riding in the front seat generally, such child safety seats are commonly placed in a vehicle's back seat, out of view from a parent or care provider. Under a number of unforseen circumstances the parent or care provider can forget that the child is in the vehicle and unintentionally leaves the child. In the unfortunate event that a child is unintentionally left in a vehicle on a hot day the result can be catastrophic, resulting in death to the child from hyperthermia. The potential for disaster is appreciated when it is considered that on days when the ambient temperature exceeds 86 degrees Fahrenheit the internal temperature of a vehicle can quickly reach 134 to 154 degrees Fahrenheit. Some deaths have even occurred on relatively mild days where the ambient temperature was not in excess of approximately 70 degrees Fahrenheit.

In providing a solution to the forgoing problem the present invention comprises a system and method to alert a parent or care provider, other individual, and/or police or other rescue personnel in the event a child is unintentionally left inside an unattended vehicle. In accordance with the broader aspects of the invention a method of preventing the unintentional abandonment or leaving of a child in an unattended vehicle utilizes an electronic system installed on a vehicle and a sensor installed on a child safety or car seat, or in the back seat of a vehicle, to alert a parent, care provider, other individual, and/or police or other rescue personnel in the event a child is unintentionally left inside an unattended vehicle.

In accordance with the more specific aspects of the invention a system comprising an electronic system and a controller device installed on a vehicle detects when a vehicle has been turned off. A sensor installed on a child safety or car seat, or in the back seat of a vehicle, then determines whether or not a child is still in the vehicle or child safety seat. If so, a timing device begins counting down from a predetermined time interval. If the sensor determines that a child is still in the vehicle or child safety seat after the predetermined time has expired a signal is communicated to a parent, care giver, other individual, and/or police or other rescue personnel via a transmitter, so as to alert same that the child has been left in the vehicle.

A vehicle equipped with the present invention will allow a parent or care provider of a child to avoid a tragic accident resulting from the child being unintentionally left in a vehicle. Were the present invention to be made mandatory by lawmakers, or voluntarily utilized by automobile or child safety seat manufacturers, the problem described above could be altogether eliminated.

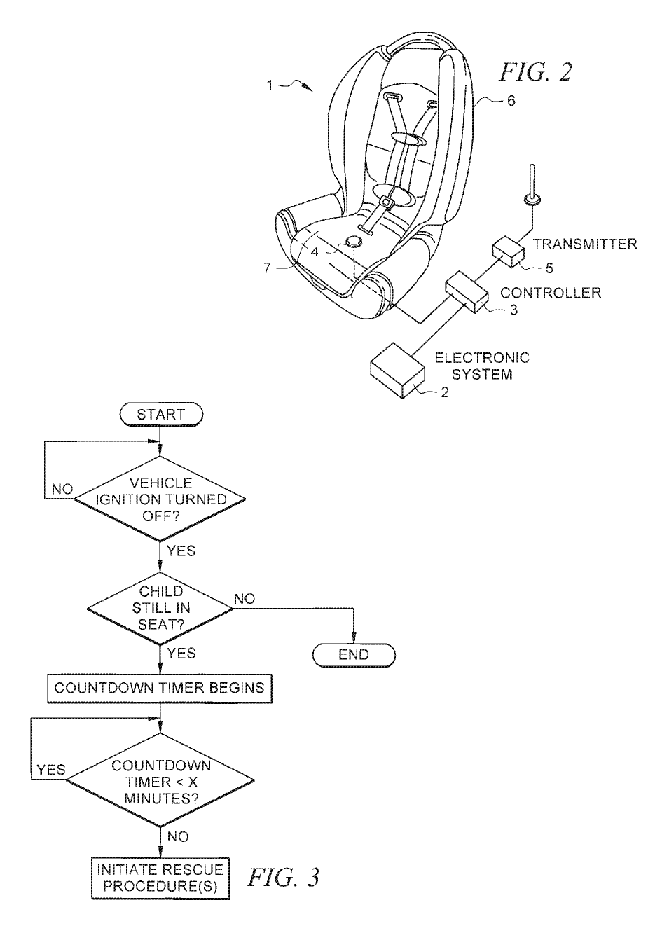

Referring to the drawings, and particularly to FIG. 2 thereof, there is shown a system 1 for preventing the unintentional abandonment or leaving of a child in an unattended vehicle. An electronic system 2 is installed on a vehicle. Most new vehicles and many older vehicles are equipped with an electronic system or otherwise utilize some type of computer system. The electronic system 2 may be integrated into a vehicle's existing electronic or computer system, or alternatively, and in vehicles that are not equipped with an electronic or computer system, the electronic system 2 may be a separate electronic system. The specific components and design of the electronic system 2 will be of the type known to those with skill in the art.

The electronic system 2 connects to a controller 3. The controller 3 interfaces with the electronic system 2 and operates a transmitter 5. The controller 3 is provided with the components necessary to send and receive electronic data to and from the electronic system 2 and interpret the data accordingly, and additionally incorporates a timing device so as allow the controller 3 to send a signal to the transmitter 5 at a predetermined interval. The controller 3 connects to, and is capable of sending to and receiving and interpreting electronic data from a sensor 4. The controller 3 also connects to the transmitter 5, and is capable of sending a signal to the transmitter 5. The transmitter 5 can be an antenna type transmitter, or any other type of suitable transmitter known in the art. In one example, a vehicles factory installed antenna is utilized. In another example, a separate antenna is utilized.

The sensor 4 is installed generally in the backseat of a vehicle. In the embodiment shown, the sensor 4 is installed in a bottom seat portion 7 of a child safety seat 6. The sensor 4 is designed to recognize when a child has been placed in the backseat generally, or in the child safety seat 6. In one example, a sensor 4 is utilized which senses the weight of a child in the child safety seat 6. In another example, a sensor 4 recognizes vital signs of a child, such as heart beat/rate and/or respiration or breathing rate. In yet another example, a sensor 4 senses movement or motion of a child. Through the controller 3, the sensor 4 is also capable of interfacing with the electronic system 2.

The sensor recognizes when a child has been placed in the backseat generally, or in the child safety seat 6, and sends a signal to the controller 3. The controller 3 then initializes recording of this electronic data. In one example, the controller 3 has an internal memory which stores data electronically, such as information received from the sensor 4 that a child is in the backseat generally, or in the child safety seat 6. In another example, the controller sends a signal to the electronic system 2, which then stores the electronic data accordingly.

The sensor 4 also initiates “activation” of the system 1. Once a signal indicating a child is present is sent by the sensor 4 to the controller 3, the system 1 is “activated.” The system 1 is “deactivated” upon the removal of the child.

Upon receiving a signal from the controller 3 that a child has been left in the backseat generally, or in the child safety seat 6, in excess of a predetermined time interval as dictated by the timer device of the controller 3, the controller 3 sends a signal to the transmitter 5. In one example, the transmitter 5 is configured so as to call a predetermined telephone number, such as the cellular telephone number of a parent or care provider. Any number of predetermined telephone numbers can be stored in the electronic system 2 or the controller 3. In the event a call is not answered, the controller 3 signals to the transmitter 5 to call the next preprogramed telephone number, and so on, in succession, until a call is answered. The controller 3 can also be programmed to call 911 or the telephone number of other rescue personnel. In this manner, proper individuals are notified that a child has been left in the vehicle. In another example, a dedicated device, such as a pager or key chain receiver can be utilized. For instance, the transmitter 5 would send a signal to the dedicated device so as to notify a parent or care provider. In yet another example, the system 1 utilizes the electronic system 2 to contact OnStar®, in vehicles so equipped, or other such service providers, so as to notify operators that a child has been left in the vehicle in question. Electronic systems such as OnStar® and the like have GPS capabilities and therefore are capable of notifying rescue personnel as to the exact location of a child needing rescue.

The system 1 can also be provided with GPS capabilities, independent from OnStar® or other such service providers, thereby allowing the system 1 to notify rescue personnel as to the exact location of a child needing rescue. In one example, the GPS is integrated into the electronic system 2 or the controller 3. In the event a child is left in a vehicle, the controller 3 sends a signal via the transmitter 5, or via an alternate transmitting means, to rescue personal thereby communicating the vehicle's exact location. A separate GPS device may also be utilized in conjunction with the system 1 to communicate a vehicle's exact location to rescuers. Were a separate GPS device is utilized, the electronic system 2 or controller 3 is configured to engage the GPS device, either by connecting to the GPS device, or by connecting the GPS device to the electronic system 2 or the controller 3, so as to allow the controller 3 to send electronic data to and receive and interpret electronic data from the GPS device. In this manner, a vehicle's exact location can be transmitted, either via the transmitter 5 or a transmitting means of the separate GPS device, to rescue personnel.

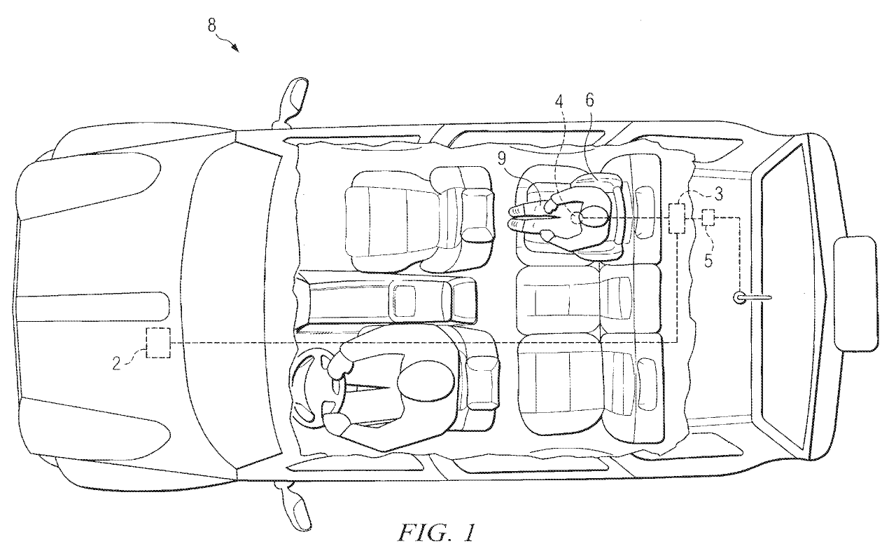

Referring now to FIG. 1, a vehicle 8 is shown wherein the system 1 of the present invention is installed. A child 9 is shown in the back seat of the vehicle 8, strapped into a child safety seat 6. The child safety seat 6 is incorporated with a sensor 4 of the present invention. The sensor 4 is connected with an electronic system 2. As is shown, the electronic system 2 can be installed at various locations on the vehicle 8, such as the front or back of the vehicle 8, depending on various factors such as whether or not the vehicle's 8 factory electronic system is utilized. The electronic system 2 is connected to a controller 3. As with the electronic system 2, the controller 3 can be installed at various locations on the vehicle 8. The controller 3 is in turn connected to a transmitter 5. The transmitter 5 can be placed either inside or outside the vehicle 8.

The system 1 is designed to run on minimal power, and can utilize its own power source, such as long life batteries. The system 1 can also be powered by a vehicle itself, such as by a vehicle's battery.

Referring now to FIG. 3, and with reference to FIG. 2, the method of the present invention is shown. Initially, a controller 3 determines that the ignition system of a vehicle has been turned off via the controller's 3 interface with an electronic system 2. As discussed in detail heretofore, the controller 3 then receives a signal from a sensor 4 indicating whether or not a child has been left in the backseat generally, or in a child safety seat 6. If the controller 3 determines that a child has not been left, the system 1 shuts down, or is “deactivated.” If, however, the controller 3 determines that a child has been left, a timing device of the controller 3 is triggered and begins counting down. The timing device of the controller 3 is programmed so as to send a signal to the transmitter 5 upon the expiration of a set time interval. In the embodiment shown, the set time interval is some increment less than five minutes. Upon the expiration of the set time interval, the controller 3 determines, by way of a signal from the sensor 4, whether or not the child is still present. If the controller 3 determines the child has been removed, the system 1 shuts down or is “deactivated.” If, however, the controller 3 determines that the child is still present, a signal is sent to a transmitter 5 so as to notify predetermined individuals as heretofore described.

1. A machine for determining the presence of a child in an unattended vehicle comprising:
means for determining that the ignition system of a vehicle has been turned off;
means for determining that a child has been left in the vehicle after the ignition system of the vehicle has been turned off; and
means responsive to a determination that a child has been left in the vehicle after the ignition system of the vehicle has been turned off for transmitting a signal indicating that a child has been left in the vehicle.

2. A process for determining the presence of a child in an unattended vehicle comprising:
determining whether the ignition system of a vehicle has been turned off;
determining whether a child has been left in the vehicle after the ignition system of the vehicle is turned off; and
responsive to a determination that a child has been left in the vehicle after the ignition system of the vehicle has been turned off transmitting a signal indicating that a child has been left in the vehicle.
